(19) United States
(12) Patent Application Publication
(10) Pub. No.: US 2021/0275376 A1
(43) Pub. Date: Sep. 9, 2021

(54) Bedpan Cushion Assembly

(71) Applicant: Joseph Miles, Brick, NJ (US)

(72) Inventor: Joseph Miles, Brick, NJ (US)

(21) Appl. No.: 16/813,378

(22) Filed: Mar. 9, 2020

(51) Int. Cl. A61G 9/00; A47K 13/26

(52) U.S. Cl. CPC A61G 9/003; A47K 13/26

(57) ABSTRACT

A bedpan cushion assembly for enhancing comfort of a bedpan includes a plurality of mating members that is each attachable to a top surface of a bedpan. A cushion is provided and the cushion is attachable to each of the mating members such that the cushion is removably attached to the bedpan. The cushion is comprised of a resiliently compressible material to enhance comfort for a user employing the bedpan.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cushion devices and more particularly pertains to a new cushion device for enhancing comfort of a bedpan.

### (2) Description of Related Art Including Information Disclosed Under 37 CFR 1.97 and 1.98.

The prior art relates to cushion devices. The prior art discloses a cushion with straps that can be strapped to a bedpan. Additionally, the prior art discloses a cushion that includes a clip that releasably engages a bedpan for retaining the cushion on the bedpan. The prior art discloses a cover that has a cushion integrated thereto for cushioning a bedpan. The prior art discloses a cushion that has a plurality of suction cups thereon for retaining the cushion on the bedpan. The prior art also discloses a disposable bedpan cushion that has an adhesive layer thereon for adhesively engaging a bedpan.

### BRIEF SUMMARY OF THE INVENTION

An embodiment of the disclosure meets the needs presented above by generally comprising a plurality of mating members that is each attachable to a top surface of a bedpan. A cushion is provided and the cushion is attachable to each of the mating members such that the cushion is removably attached to the bedpan. The cushion is comprised of a resiliently compressible material to enhance comfort for a user employing the bedpan.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cushion of a bedpan cushion assembly according to an embodiment of the disclosure.

FIG. 2 is a bottom view of a cushion of an embodiment of the disclosure.

FIG. 3 is a right side view of a cushion of an embodiment of the disclosure.

FIG. 4 is a cross sectional view taken along line 4-4 of FIG. 3 of an embodiment of the disclosure.

FIG. 5 is an exploded in-use view of an embodiment of the disclosure.

### DETAILED DESCRIPTION OF THE INVENTION

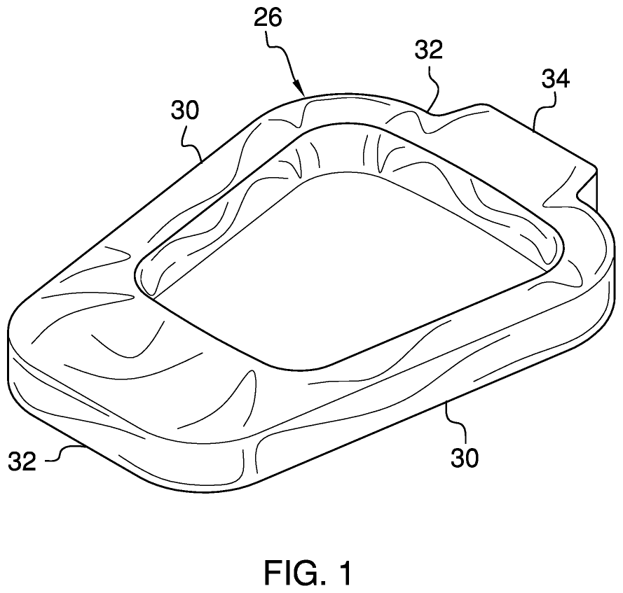

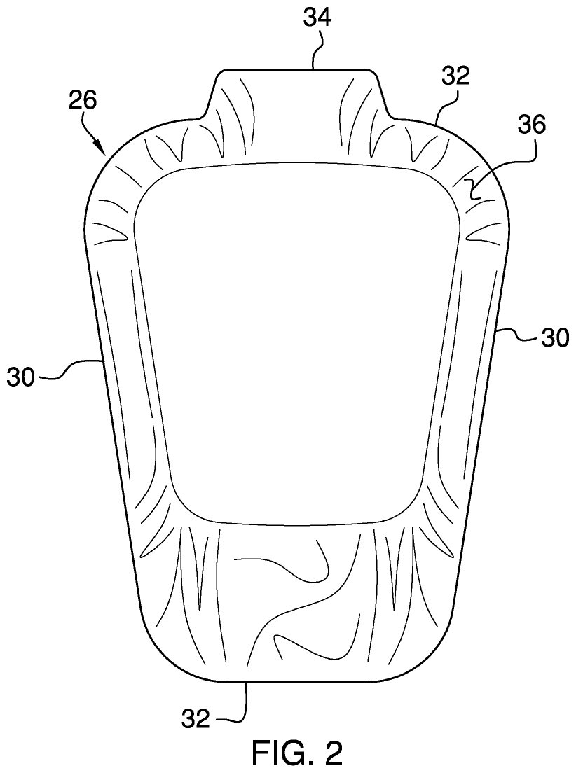

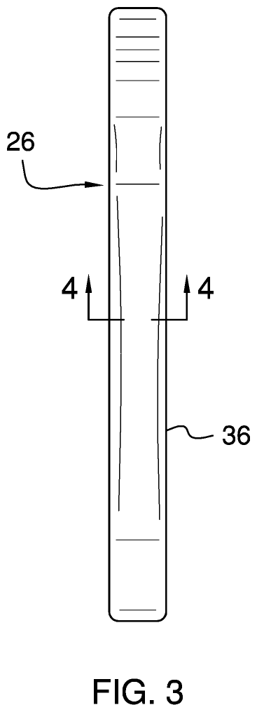

With reference now to the drawings, and in particular to FIGS. 1 through 5 thereof, a new cushion device embodying the principles and concepts of an embodiment of the disclosure and generally designated by the reference numeral 10 will be described.

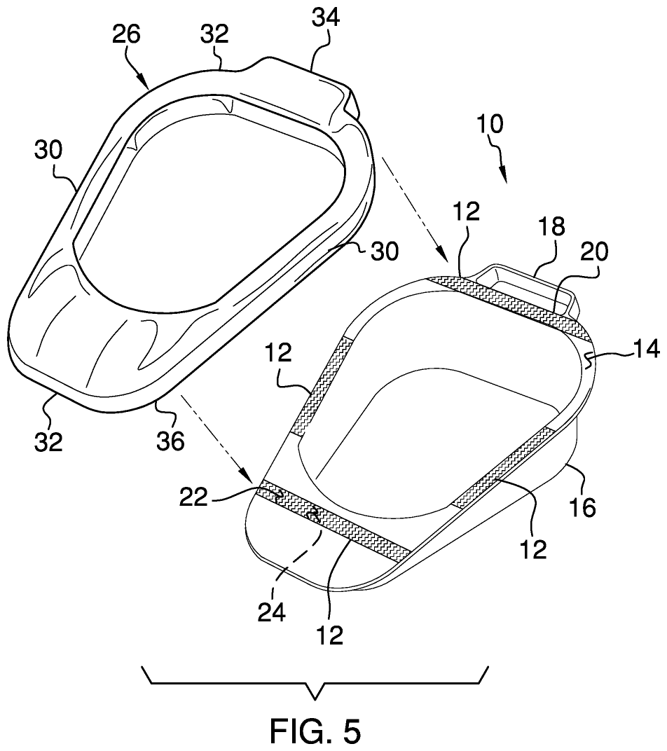

As best illustrated in FIGS. 1 through 5, the bedpan cushion assembly 10 generally comprises a plurality of mating members 12 that is each of the mating members 12 is attachable to a top surface 14 of a bedpan 16. The bedpan 16 may be a bedpan of any conventional design for use with a bedridden user. Additionally, as is most clearly shown in FIG. 5, the bedpan 16 may have a handle portion 18 extending away from a back side 20 of the bedpan 16 for gripping the bedpan 16. Each of the mating members 12 has a first surface 22 and a second surface 24, and the second surface 24 of each of the mating members 12 comprises an adhesive material for adhesively engaging the top surface 14 of the bedpan 16.

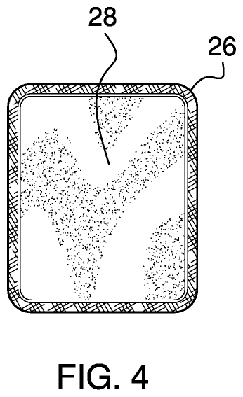

A cushion 26 is provided and the cushion 26 is attachable to each of the mating members 12 for removably attaching the cushion 26 to the bedpan 16. The cushion 26 is comprised of a resiliently compressible material to enhance comfort for a user employing the bedpan 16. As is most clearly shown in FIG. 4, the cushion 26 may be hollow and filled with a compressible gel 28 or other similar type of material. The cushion 26 comprises a pair of first portions 30 each extending between a pair of second portions 32. The first portions 30 are spaced apart from each other such that the cushion 26 defines a closed loop.

As is most clearly shown in FIGS. 1, 2, and 5, a respective one of the second portions 32 has a prominence 34 extending outwardly therefrom. The prominence 34 is aligned with the handle portion 18 of the bedpan 16 for cushioning the handle portion 18. The cushion 26 has a bottom surface 36 and the bottom surface 36 is positionable on each of the mating members 12 when the mating members 12 is positioned on the bedpan 16. Moreover, each of the mating members 12 releasably engages the bottom surface 36 for retaining the cushion 26 on the bedpan 16. Each of the mating members 12 may comprise a hook portion of a hook and loop fastener and the bottom surface 36 of the cushion 26 may comprise a looped fabric. In this way the hook portion of the hook and loop fastener can engage the bottom surface 36 of the cushion 26. Additionally, each of the first portions 30 may angle outwardly between each of the second portions 32 such that the cushion 26 has a trapezoidal shape.

In use, each of the mating members 12 is attached to the top surface 14 of the bed pan and the mating members 12 are distributed around the bedpan 16. The cushion 26 is positioned on the top surface 14 of the bedpan 16 such that the cushion 26 is coextensive with, and completely covers, the top surface 14 of the bedpan 16. In this way the cushion 26 enhances comfort for the user when the user lies on the bedpan 16. Additionally, each of the mating members 12 releasably engages the cushion 26 for retaining the cushion 26 on the bedpan 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim

1. A bedpan cushion assembly for enhancing comfort for a user employing a bedpan, said assembly comprising:
a plurality of mating members, each of said mating members being attachable to a top surface of a bedpan; and
a cushion being attachable to each of said mating members wherein said cushion is configured to be removably attached to the bedpan, said cushion being comprised of a resiliently compressible material wherein said cushion is configured to enhance comfort for a user employing the bedpan.

2. The assembly according to claim 1, wherein each of said mating members has a first surface and a second surface, said second surface of each of said mating members comprising an adhesive material wherein said second surface is configured to adhesively engage the top surface of the bedpan.

3. The assembly according to claim 1, wherein said cushion comprises a pair of first portions each extending between a pair of second portions, said first portions being spaced apart from each other such that said cushion defines a closed loop.

4. The assembly according to claim 3, wherein said cushion has a bottom surface, said bottom surface being positionable on each of said mating members when said mating members is positioned on the bedpan, each of said mating members releasably engaging said bottom surface wherein said cushion is configured to be retained on the bedpan.

5. A bedpan cushion assembly for enhancing comfort for a user employing a bedpan, said assembly comprising:
a plurality of mating members, each of said mating members being attachable to a top surface of a bedpan, each of said mating members having a first surface and a second surface, said second surface of each of said mating members comprising an adhesive material wherein said second surface is configured to adhesively engage the top surface of the bedpan; and
a cushion being attachable to each of said mating members wherein said cushion is configured to be removably attached to the bedpan, said cushion being comprised of a resiliently compressible material wherein said cushion is configured to enhance comfort for a user employing the bedpan, said cushion comprising a pair of first portions each extending between a pair of second portions, said first portions being spaced apart from each other such that said cushion defines a closed loop, said cushion having a bottom surface, said bottom surface being positionable on each of said mating members when said mating members is positioned on the bedpan, each of said mating members releasably engaging said bottom surface wherein said cushion is configured to be retained on the bedpan.

6. A bedpan cushion system for enhancing comfort for a user employing a bedpan, said assembly comprising:
a bedpan having a top surface;
a plurality of mating members, each of said mating members being attachable to said top surface of said bedpan, each of said mating members having a first surface and a second surface, said second surface of each of said mating members comprising an adhesive material to adhesively engage the top surface of the bedpan; and
a cushion being attachable to each of said mating members for removably attaching to said bedpan, said cushion being comprised of a resiliently compressible material wherein said cushion is configured to enhance comfort for a user employing the bedpan, said cushion comprising a pair of first portions each extending between a pair of second portions, said first portions being spaced apart from each other such that said cushion defines a closed loop, said cushion having a bottom surface, said bottom surface being positionable on each of said mating members when said mating members is positioned on the bedpan, each of said mating members releasably engaging said bottom surface for retaining said cushion on the bedpan.
